(19) United States
(12) Patent Application Publication
(10) Pub. No.: US 2025/0384406 A1
(43) Pub. Date: Dec. 18, 2025

(54) METHOD AND SYSTEM FOR GENERATING MEETING MINUTES

(71) Applicants: Inventec (Pudong) Technology Corporation, Shanghai (CN); INVENTEC CORPORATION, TAIPEI CITY (TW)

(72) Inventors: Wei-Chao CHEN, TAIPEI CITY (TW); Po-Hsuan HUANG, TAIPEI CITY (TW); Chi Zen PENG, TAIPEI CITY (TW); Jui-Chang CHEN, TAIPEI CITY (TW)

(21) Appl. No.: 18/820,254

(22) Filed: Aug. 30, 2024

(30) Foreign Application Priority Data
Jun. 14, 2024 (CN) 202410775243.6

(51) Int. Cl. G06Q 10/1093; G06V 10/25; G06V 20/40; G06V 40/16; G06V 40/70; G10L 17/02; G10L 17/04; G10L 17/10; G10L 25/57; G10L 25/63

(52) U.S. Cl. CPC G06Q 10/1093; G06V 10/25; G06V 20/41; G06V 40/161; G06V 40/172; G06V 40/70; G10L 17/02; G10L 17/04; G10L 17/10; G10L 25/57; G10L 25/63

(57) ABSTRACT

A method for generating meeting minutes includes the follow steps. A video signal, an audio signal and source localization information of a video conference are obtained. Face recognition is performed on multiple image frames of the video signal to obtain multiple face recognition results. Voice recognition is performed on multiple audio segments of the audio signal to obtain multiple voice recognition results at multiple timestamps. The voice recognition results are matched with the face recognition results according to the source localization information, in order to obtain multiple speaker's identities. Speech to text transcription is performed on the audio segments of the audio signal to obtain a transcript. The speaker's identities are attached to the transcript according to the timestamps, in order to obtain a context. Context understanding is performed on the context to obtain a meeting minutes report.

### CROSS-REFERENCE TO RELATED APPLICATION

This application claims priority to CN Application Serial Number 202410775243.6, filed Jun. 14, 2024, which is herein incorporated by reference in its entirety.

### BACKGROUND

### Field of Invention

The present invention relates to a method and system for generating meeting minutes. More particularly, the present invention relates to method and system capable for generating meeting minutes of multiple-participant video conference.

### Description of Related Art

Nowadays, conference system can automatically generate a transcript based on artificial intelligence for audio to text conversion, and then some conference systems may consider the transcript as a context, and directly utilize text summarization techniques to perform reading comprehension on the transcript to generate meeting minutes.

However, a conference for multi-person dialogue and interaction is different from a single text; the transcript generated by simply converting audio to text cannot truly represent the real context of the multi-person conference, it limits the practical application of this function. To generate complete meeting minutes report, the context of the multi-person conference need to be considered. When conference summary is performed, there are serval factors need to be considered to generate the appropriate meeting minutes, for example, the participant's identities and emotions during interactions; these usually are not covered by a single text semantic understanding.

On the other hand, the conference may have various types in real life, which may be entity, online or the combination of the above, the interaction process of the actual conference often is composed by multi-modal, such as the participants may use cameras, microphones, texts and devices of various modal. These audio and video devices may not be fully equipped in one conference, such as, a camera being in off, a same microphone of a device used by multiple participants or multiple participants entering the conference by using a single account are the typical usage scenarios.

Furthermore, the participants in a conference may change with time. For example, the inviter may be unable to attend due to unscheduled commitments, or people not include in the conference list join the conference temporary. In a scenario that multiple participants share the same microphone, the participants are hard to determine the speaker's identity. In the multi-participants conference, participants are hard to recognize everyone's identity, resulting the confusion and the information of the multi-participants conference is hard to be recorded.

Summary, how to provide a method and system for generating meeting minutes to solve the above problems are an important issue in this field.

### SUMMARY

In some embodiments of the present disclosure, a multi-modal system architecture for improving the experience of the multiple participants and completing the context of the conference. The method and the system of the present disclosure receive multi-modal inputs including videos, audios, text inputs and account inputs at the same time, so as to perform the participant's identities analysis and meeting context analysis, and to immediately attach the identities and send the main points of the meeting considered under the entire context pf the conference.

The present disclosure provides a method for generating meeting minutes includes following steps. A video signal, an audio signal and sound source localization information of a video conference are obtained. Face recognition is performed on a plurality of image frames of the video signal to obtain a plurality of face recognition results. Voice recognition is performed on a plurality of audio segments of the audio signal to obtain a plurality of voice recognition results at a plurality of timestamps. The voice recognition results are matched with the face recognition results according to the sound source localization information, to obtain a plurality of speaker's identities. Speech to text transcription is performed on the audio segments of the audio signal to obtain a transcript. The speaker's identities are attached to the transcript according to the timestamps, to obtain a context. Context understanding is performed on the context to obtain a meeting minutes report.

In some embodiments, the voice recognition results and the face recognition results comprise a plurality of known identities and at least one unknown identity.

In some embodiments, the voice recognition results comprise a plurality of unknown identities, and the face recognition results comprise a plurality of known identities.

In some embodiments, the method further includes the following steps. The speaker's identities are determined from the known identities, according to the sound source localization information and the face recognition results. The unknown identities comprised in the voice recognition results are updated with the speaker's identities, according to the timestamps.

In some embodiments, the voice recognition results comprise a plurality of known identities, and the face recognition results comprise a plurality of unknown identities.

In some embodiments, the sound source localization information comprises at least one of an angle and a direction of each of sound sources.

In some embodiments, the face recognition results comprise coordinates of a plurality of facial bounding boxes in the image frames and an identity corresponding to each of the facial bounding boxes.

In some embodiments, the method further includes the following steps. A text input associated with at least one user profile is obtained. The text input is inserted into the transcript according to time series, to generate an updated transcript. The speaker's identities are attached to the updated transcript according to the timestamps, to obtain the context. Context understanding is performed on the context to obtain the meeting minutes report.

In some embodiments, the method further includes the following steps. Context understanding is performed on the context, to obtain a plurality of emotional semantics of a plurality of sentences comprised in the context. A portion of the context is removed according to the emotional semantics, to generate an updated context. Summary extraction is performed on the updated context, to obtain the meeting minutes report.

The present disclosure provides a system for generating meeting minutes includes a memory configured to store a plurality of instructions and data and a processor electrically connected to the memory. The processor accesses the instructions and data stored in the memory to execute the following steps. Obtain a video signal, an audio signal and sound source localization information of a video conference. Perform face recognition on a plurality of image frames of the video signal to obtain a plurality of face recognition results. Perform voice recognition on a plurality of audio segments of the audio signal to obtain a plurality of voice recognition results at a plurality of timestamps. Match the voice recognition results with the face recognition results according to the sound source localization information, to obtain a plurality of speaker's identities. Perform speech to text transcription on the audio segments of the audio signal to obtain a transcript. Attach the speaker's identities to the transcript according to the timestamps, to obtain a context. Perform context understanding on the context to obtain a meeting minutes report.

### BRIEF DESCRIPTION OF THE DRAWINGS

The present disclosure can be more fully understood by reading the following detailed description of the embodiment, with reference made to the accompanying drawings as follows.

FIG. 1 depicts a schematic diagram of a system for generating meeting minutes according to some embodiments of the present disclosure.

FIG. 2 depicts a flow chart of a method for generating meeting minutes according to some embodiments of the present disclosure.

FIG. 3 depicts a flow chart of a method for generating meeting minutes according to some embodiments of the present disclosure.

FIG. 4 depicts a schematic diagram of operations for generating meeting minutes according to some embodiments of the present disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. Description of the operation does not intend to limit the operation sequence. Any structures resulting from recombination of elements with equivalent effects are within the scope of the present disclosure. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

In the description herein and throughout the claims that follow, unless otherwise defined, all terms have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In the description herein and throughout the claims that follow, the terms “comprise” or “comprising,” “include” or “including,” “have” or “having,” “contain” or “containing” and the like used herein are to be understood to be open-ended, i.e., to mean including but not limited to.

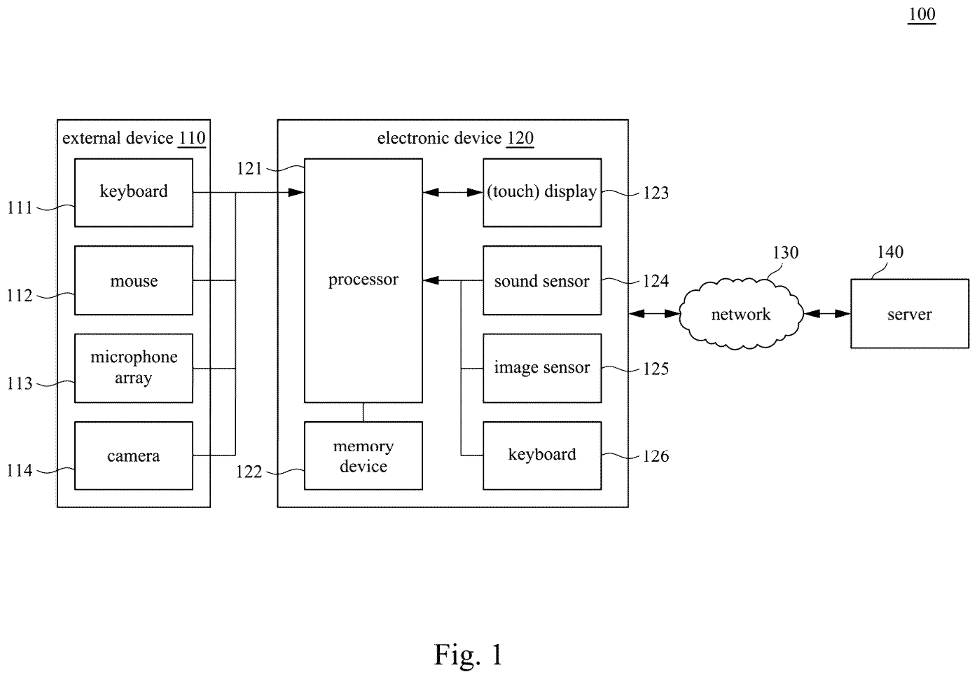

A description is provided with reference to FIG. 1. FIG. 1 depicts a schematic diagram of a system 100 for generating meeting minutes according to some embodiments of the present disclosure.

As shown in FIG. 1, the system 100 for generating meeting minutes includes an external device 110, an electronic device 120 and a server 140. In some embodiments, the external device 110 includes a keyboard 111, a mouse 112, a microphone array 113 and a camera 114. In some embodiments, the microphone array 113 has a sound source localization function.

In some embodiments, the microphone array localizes sources of sounds based on time difference of arrival, beamforming and/or other sound localization algorithms, so as to obtain sound source localization information. In some embodiments, the said sound source localization information includes at least one of an angle and a direction of each of sound sources. In some embodiments, the sound source localization information includes each speaker's angle/direction in one conference venue during the conference.

In some embodiments, the electronic device 120 is electrically connected to an external device 110, in order to receive sounds, images and/or a text input. In some embodiments, the electronic device 120 includes a processor 121, a memory device 122, a (touch) display 123, a sound sensor 124, an image sensor 125 and a keyboard 126. In some embodiments, a user may adopt the camera 114 included in the external device 110 or the image sensor 125 of the electronic device 120 to capture images in a conference venue, and the user may adopt the microphone array 113 or the sound sensor 124 to receive the sounds in the conference venue and to perform the sound source localization. The said images are transmitted through the network 130 to the server 140, in order to generate a video signals and an audio signal of the video conference by streaming images (and sounds).

In some embodiments, the user inputs a text by using the keyboard 111, the mouse 112 included in the external device 110 and/or the touch display 123, the keyboard 126 of the electronic device 120.

To be noted that, FIG. 1 only descripts one electronic device, while it can realize that there are electronic devices equipped in each of conference venues to make a video conference. In some embodiments, the equipment configured in each conference venue corresponds to the electronic device 120 and/or the external device 110 in FIG. 1. In some embodiments, the server 140 receives a video, an audio, sound source localization information and/or other information from each conference venue, as such speakers correspond to an audio transcript during the conference can be recognized according to the video, the audio, the sound source localization information and/or the other information of each conference venue. As a result, a meeting minutes report can be generated based on the transcript which includes speakers identifies. In some embodiments, the meeting minutes report refers to a meeting summary. In some embodiments, the meeting minutes report refers to a meeting abstract, which is not intend to limit the present disclosure.

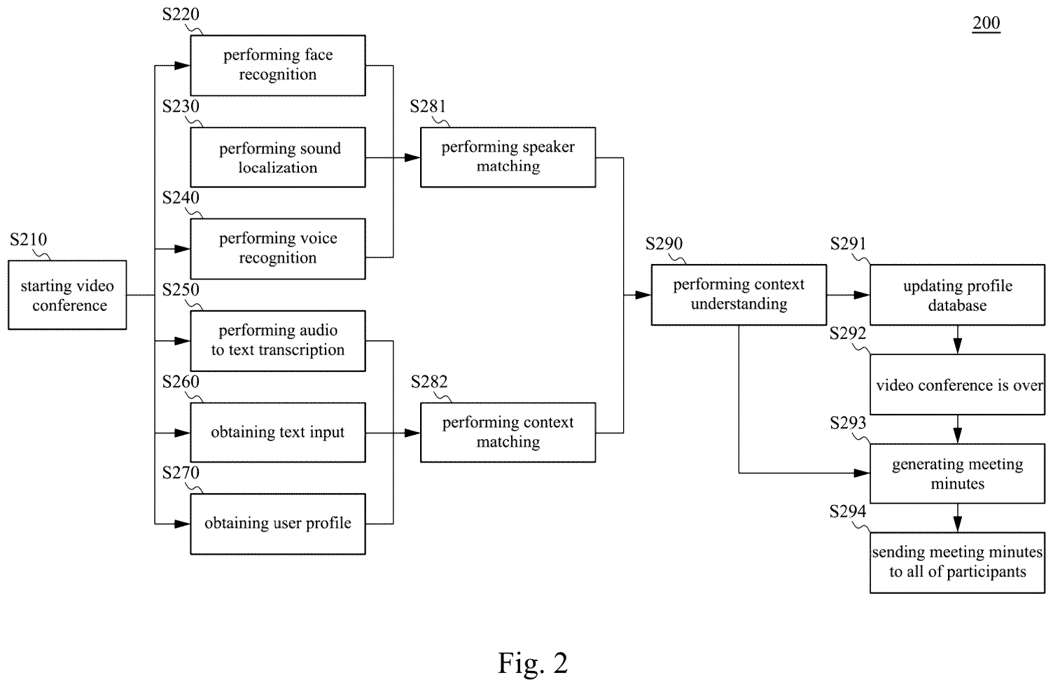

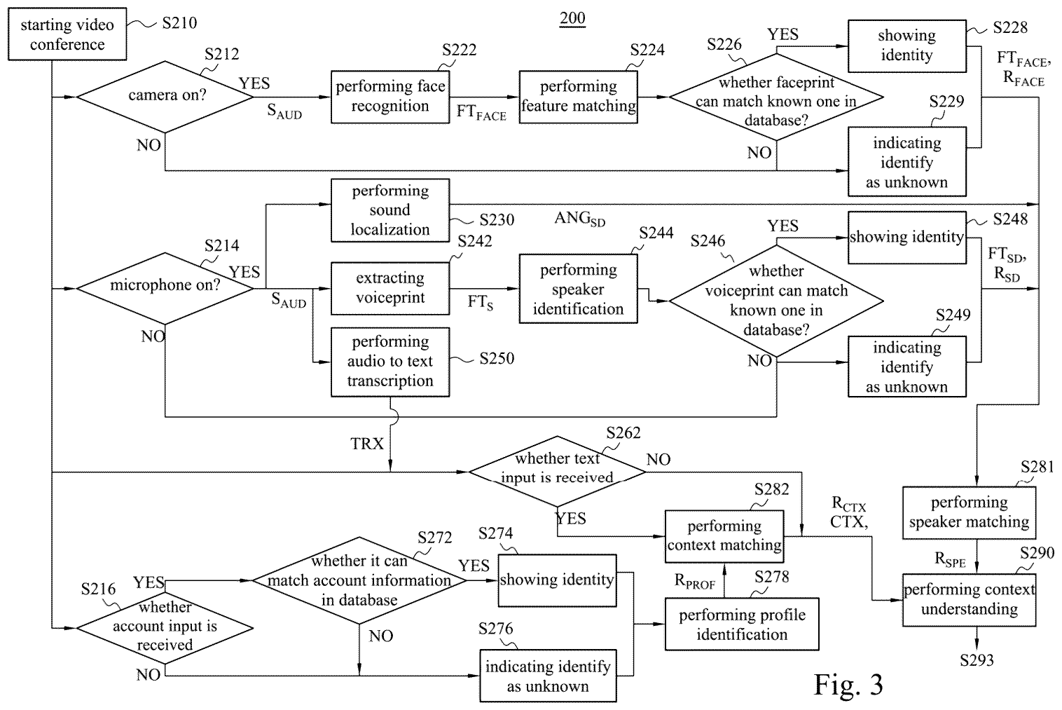

In some embodiments, the server 140 includes a memory and a processor, the memory is configured to store data and computer executable instructions. The processor is electrically coupled to the memory, and the processor access the data and instructions from the memory to execute steps included in the method 200 for generating meeting minutes in FIG. 2 and FIG. 3. In some embodiments, the memory includes a dynamic memory, a state memory, a hard disk and/or a flash memory. In some embodiments, the processor includes a central processing unit (CPU), a graphic processing unit (GPU), a tensor processing unit (TPU), an application specific integrated circuit (ASIC) or any equivalent processing unit. Therefore, it is not intended to limit the present disclosure.

A description is provided with reference to FIG. 1 and FIG. 2. FIG. 2 depicts a flow chart of a method 200 for generating meeting minutes according to some embodiments of the present disclosure. As shown in FIG. 2, the method 200 for generating meeting minutes includes steps S210˜S294. In some embodiments, steps S210˜S294 can be performed by the system 100 for generating meeting minutes in FIG. 1. In some embodiments, the server 140 receives the video, the sound, the text input, the account from the device/equipment at each conference venue, and the aforesaid four-modal are weighted associated with each other and are integrated, performing the analysis of the conference context. When the video conference is over, the system sends a meeting minutes report to the participants based on the aforementioned information, and updates the profile database at the same time, the said database stores person's data and historical data, including data of voice prints, videos, accounts, behavior analysis, etc., provided to the following conference, in order to continued improve the completeness of system, automatically. In some embodiments, the aforementioned four-modal includes an image branch, an audio branch, a text branch and an account branch. In some embodiments, step S220 corresponds to the image branch, and steps S230˜S240 corresponds to the audio branch. In some embodiments, steps S250˜S260 corresponds to the text branch, and step S270 corresponds to the account branch.

In step S210, a video conference starts. In some embodiments, after participants from every conference venues enter the video conference, the meeting starts.

In step S220, face recognition is performed. In some embodiments, a face recognition task can be performed by a face recognition neural network. In some embodiments, the face recognition task can be performed by a face recognition neural network whose main architecture is YOLOv5. In the other embodiments, the face recognition task can be other performed by neural network which can recognize the faceprint, which is not intended to limit the present disclosure. The face detection is performed on the image frames of the video signal during the video conference, so as to obtain all of facial bounding boxes corresponding to participants at every conference venues. Based on data in the database, the participants corresponding to these facial bounding boxes are identified, resulting in face recognition results. For example, if facial bounding boxes of one or more participants are identified as known identities, the identities are respectively attached to these facial bounding boxes. On the other hand, if facial bounding boxes of one or more participants are identified as known identities unknown identities, the unknown identities are respectively attached to these facial bounding boxes. In some embodiments, a portion of the aforesaid participants in a conference venue can enter the video conference by an account, and the other portion of the aforesaid participants in different conference venues can enter the video conference by different accounts.

In step S230, sound localization is performed. In some embodiments, if multiple participants in the same conference venue enter the video conference by the same account to begin the video conference with other participants in the other conference venues, and the identities of the participants in the same conference venue cannot be obtained from the account. Therefore, in the multi-person conference, the microphone array 113 can perform the sound source localization, so as to obtain sound source localization information. The said sound source localization information includes an angle and/or a direction of each speaker at a conference venue during the video conference.

In step S240, voice recognition is performed. In some embodiments, the voice recognition can be a voice recognition task, and the voice recognition task can be performed by a voice recognition neural network. In some embodiments, the voice recognition task can be performed by voice recognition neural network whose machine learning architecture is based on PyTorch. In the other embodiments, the voice recognition can be performed by a neural building modal on a basis of pyannote.audio or can be performed by other neural networks capable for recognizing the voice print.

In some embodiments, the voice recognition results obtained in step S240 and the face recognition results obtained in step S210 include multiple known identities and at least one unknown identity.

In some embodiments, the voice recognition results obtained in step S240 include multiple unknown identities, and the face recognition results obtained in step S210 include multiple known identities. In some embodiments, the voice recognition results obtained in step S240 are multiple unknown identities, and the face recognition results obtained in step S210 are multiple known identities.

In some embodiments, the voice recognition results obtained in step S240 include multiple known identities, and the face recognition results obtained in step S210 include multiple unknown identities. In some embodiments, the voice recognition results obtained in step S240 are multiple known identities, and the face recognition results obtained in step S210 are multiple unknown identities.

In step S281, speaker matching is performed. In some embodiments, the voice recognition results are matched with the face recognition results according to the sound source directions obtained in step S230, so as obtain speaker's identities at corresponding timestamps. In some embodiments, the position of the microphone array in the conference venue is known; the voice recognition results can be compared and associated with the face recognition results according to the sound source angles. In some embodiments, face recognition results include sizes and coordinates of the facial bounding boxes in the image frames of the video conference and the information of known or unknown identity attached to each of the facial bounding boxes.

In an embodiment, if a voice recognition result at a timestamp is an unknown identity and face recognition results at the timestamp are known identities, a speaker's facial bounding box can be obtained by comparing a sound source angle with coordinates of the facial bounding boxes in the images, and the speaker's identity can be obtained according to the known identity attached to the facial bounding box of the speaker. In this case, the speaker's identity and the speaker's voiceprint or voice features can be added into database; as such the profile data of this participant can be updated. In another embodiment, if a voice recognition result at a timestamp is known identity, and face recognition results at the timestamp are unknown identity, a speaker's facial bounding box can be obtained by comparing a sound source angle with coordinates of the facial bounding boxes in the images, and the speaker's identity can be obtained according to the known identity attached to the audio segment corresponding to this timestamp. In this case, the speaker's identity and the speaker's faceprint or facial features can be added into database; as such the profile data of this participant can be updated. In the other embodiment, if a voice recognition result at a timestamp is known identity and face recognition results at the timestamp are known identities, the voice recognition results and the face recognition results are weighted associated according to a sound angle, so as to improve the accuracy of speaker recognition.

In step S250, audio to text transcription is performed. In some embodiments, audio to text transcription is performed on multiple audio segments of the audio signal, in order to obtain a transcript TRX. In some embodiments, a task of speech to text transcription can be performed by a convolutional neural network. In some embodiments, a task of speech to text transcription can be performed by convolutional neural network whose main architecture is Whisper. In the other embodiments, a task of speech to text transcription can be performed by Maestro or other neural network capable for converting audio to text, which is not intended to limit the present disclosure.

In step S260, a text input is obtained. In some embodiments, the text input by a user is received from a keyboard 111 or 126, a mouse 112 or a (touch) display 123.

In step S270, user profiles are obtained. In some embodiments, text inputs can be associated to the user profiles in the video conference.

In step S282, context matching is performed. In some embodiments, text inputs are inserted into the transcript TRX according to the time series, so as to obtain an updated transcript.

In step S290, context understanding is performed. In some embodiments, the speaker's identities are attached to the transcript TRX or the updated transcript, so as to obtain a context, and the context understanding is performed on the context, in order to obtain a meeting minutes report in step S293. In some embodiments, step 290 can be followed by step S291 or S293.

In step S291, a profile database is updated. In some embodiments, the speaker matching results obtained in step S281 can be used to update the individual data (such as, a faceprint, a voiceprint, account data or behavior analysis). In some embodiments, the context obtained in step S290 can be used to update conference data in database, in order to provide the continuous use in the follow conference.

In step S292, the video conference is over.

In step S294, a meeting minutes report is sent to all of participants.

A description is provided with reference to FIG. 1, FIG. 2 and FIG. 3. FIG. 3 depicts a flow chart of a method 200 for generating meeting minutes according to some embodiments of the present disclosure. The method 200 for generating meeting minutes includes step S210˜S294. In some embodiments, all of steps in FIG. 3 can be performed by the system 100 for generating meeting minutes in FIG. 1. In some embodiments, all of steps in FIG. 3 can be performed by the server 140 in FIG. 1. In some embodiments, step S212 and steps S222˜S229 correspond to an image branch, and step S230 and steps S242˜S249 correspond to a sound branch. In some embodiments, step S250 and step S262 correspond to a text branch, and steps S272˜S278 correspond to an account branch. In some embodiments, step S220 in FIG. 2 includes steps S222˜S229 for face recognition, and step S240 in FIG. 2 includes steps S242˜S249 for voice recognition. In some embodiments, step S260 in FIG. 2 includes step S262, and step S270 in FIG. 2 includes steps S272˜S278.

In step S212, whether the camera is on is determined. In some embodiments, if the camera is on, and images of a conference venue can be captured and transmitted to the server to perform the image streaming, so as to obtain a video signal S_{VID} of the video conference. If the camera is off, the person's identify is indicated as unknown in the face recognition branch.

In step S222, face recognition is performed. In some embodiments, the face recognition is performed on image frames of the video signal S_{VID}, so as to generate facial bounding boxes and a faceprint FT_{FACE} included in each facial bounding box.

In step S224, feature matching is performed. In some embodiments, the faceprint FT_{FACE} included in each facial bounding box is matched with faceprint data in the database.

In step S226, whether faceprint can match known one in database is determined. If YES, step S228 is performed to show the identity. If No, step S229 is performed, the person's identify is indicated as unknown in the face recognition branch. As a result, the face recognition results R_{EACE} can be obtained based on the facial bounding boxes. The face recognition results R_{EACE} includes known/unknown identity of person's face included in each facial bounding box.

In step S230, the sound source localization is performed to obtain sound source angle ANG_{SD}.

In step S214, whether the microphone is on is determined. In some embodiments, if the microphone on, and sound of a conference venue can be recorded and transmitted to the server to perform streaming, so as to obtain an audio signal S_{AUD} of the video conference. If the microphone is off, the person's identify is indicated as unknown in the sound recognition branch.

In step S242, voiceprint is extracted. In some embodiments, a voiceprint FT_{SD} is extracted from an audio segment of the audio signal.

In step S244, speaker identification is performed. In some embodiments, the voiceprint FT_{SD} of the audio segment is matched with voiceprint data stored in the database.

In step S246, whether voiceprint can match known one in database is determined. If YES, step S248 is performed to show identity. If No, step S249 is performed, the person's identify is indicated as unknown in the voice recognition branch. As a result, the voice recognition results R_{SD} can be obtained based on the audio segments. The voice recognition results R_{EACE} includes known/unknown identity of person's voice in each audio segment.

In step S250, audio to text transcription is performed. In some embodiments, the audio to text transcription is performed on each audio segment of the audio signal, in order to obtain the transcript TRX.

In step S216, whether account inputs are received is determined. In some embodiments, accounts which are used to attend the video conference are obtained.

In step S272, whether the account inputs can match account information in database. If the a user attends the video conference by an account including an known identity, such as, an account of a video conference software or an known email address, this branch may compare account information with data in the database, and if the account information is stored in the database, the identity corresponds to the account is indicated as the identity stored in the database; otherwise, the identity is indicated as unknown. The identity corresponds to the account is transmitted to the text branch for following process. If there is a match, step S274 is performed to show identity. If there is no match, step S276 is performed to indicate the unknown.

In step S278, profile identification is performed. Profile data R_{PROF} (such as, person's identity, company's name or other associated information) of accounts used for attending the video conference (such as, accounts of the video conference software) are obtained.

In step S262, whether text input is received is determined. If No, the transcript TRX is directly output and step S293 is performed. If YES, step S282 is performed.

In step S282, context matching is performed. In some embodiments, the text inputs corresponding to the profile data R_{PROF} are inserted into the transcript TRX, so as to generate the updated transcript according to a time series, and the speaker's identities are attached to the updated transcript according to the timestamps, so as to obtain the context.

In step S290, context understanding is performed. In some embodiments, the context understanding is performed on the context to obtain a meeting minutes report in step S293. In some embodiments, the context understanding is performed on the context to obtain multiple emotional semantics from the context, and a portion content of the context is removed according to the emotional semantics to generate an updated context. In some embodiments, summary extraction is performed on the updated context to obtain a meeting minutes report.

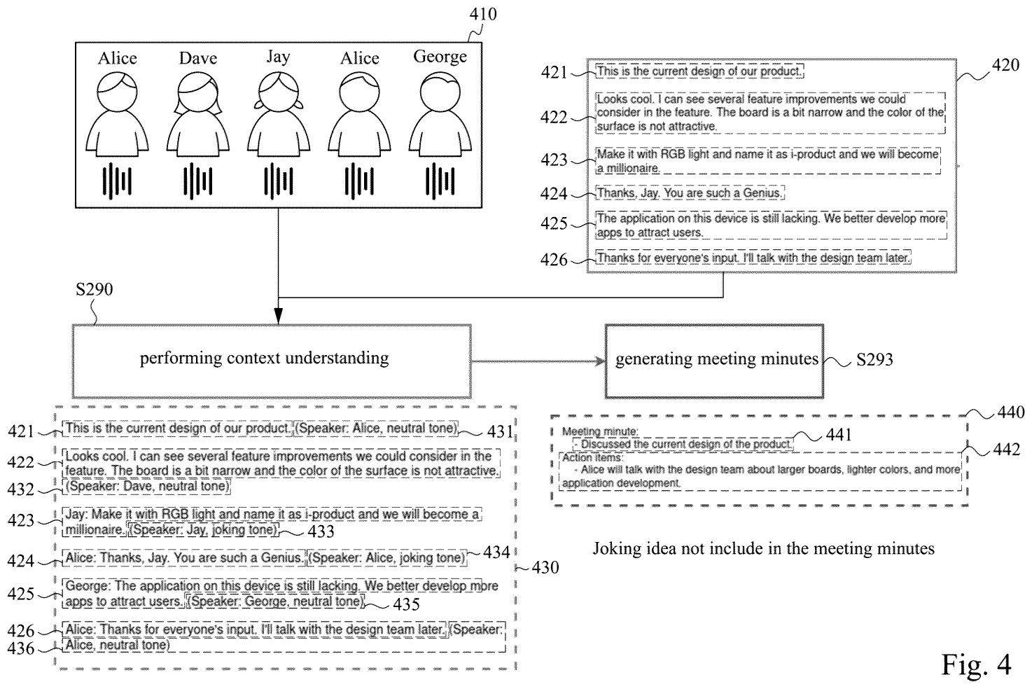

A description is provided with reference to FIG. 4. FIG. 4 depicts a schematic diagram of operations for generating meeting minutes according to some embodiments of the present disclosure. In some embodiments, the context understanding operation in step S290 can be performed by context understanding module. The context understanding module combines the speaker's identities, the emotional semantics and the context to summarize main points of the meeting based on the entire context, and the context understanding module attaches the corresponding speaker's identities to the meeting minutes report. The meeting minutes report can be automatically sent to all of participants which are identified when the video conference is over. In some embodiments, the context understanding module can be implemented by a summary extraction neural network. In some embodiments, the context understanding module can be implemented by a contextual sentiment neural network. In some embodiments, the context understanding module can be implemented by a cross-modal neural network for video and/or audio emotion recognition. In some embodiments, the context understanding module can be implemented by a neural network capable for process multi-person dialogue sentiment analysis. Therefore it is not intended to limit the present disclosure.

As shown in FIG. 4, in step S290, based on the voice features and facial features 410 of the participants, the speaker's identities respectively correspond to the sentence 421˜426 included in the transcript 420 and the emotional semantic 431˜436 respectively correspond to the sentence 421˜426 included in the transcript 420 can be obtained, resulting in the context 430. In step S293, the meeting minutes report 440 includes the meeting title 441 and the action item 442 included the speaker's identity, and the joking content can be removed from the transcript 420, such that the unimportant content in the meeting minutes report 440 can be reduced, in order to improve the quality of the meeting minutes report 440.

Summary, the system 100 and the method 200 for generating meeting minutes can improve the condition that the database does not include the known voice print data by matching the faceprint with the voice print. As a result, under a condition of the database including known face data without the voice print data, different speaker's identities in the same conference venue are able to be recognized. Furthermore, by attaching the speaker's identities to the context generated from the transcript TRX, it can improve the context understanding based on the multi-person dialogue, in order to generate the meeting minutes report having better quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for generating meeting minutes, comprising:
obtaining a video signal, an audio signal and sound source localization information of a video conference;
performing face recognition on a plurality of image frames of the video signal to obtain a plurality of face recognition results;
performing voice recognition on a plurality of audio segments of the audio signal to obtain a plurality of voice recognition results at a plurality of timestamps;
matching the voice recognition results with the face recognition results according to the sound source localization information, to obtain a plurality of speaker's identities;
performing speech to text transcription on the audio segments of the audio signal to obtain a transcript;
attaching the speaker's identities to the transcript according to the timestamps, to obtain a context; and
performing context understanding on the context to obtain a meeting minutes report.

2. The method of claim 1, wherein the voice recognition results and the face recognition results comprise a plurality of known identities and at least one unknown identity.

3. The method of claim 1, wherein the voice recognition results comprise a plurality of unknown identities, and wherein the face recognition results comprise a plurality of known identities.

4. The method of claim 3, further comprising:
determining the speaker's identities from the known identities, according to the sound source localization information and the face recognition results; and
updating the unknown identities comprised in the voice recognition results with the speaker's identities, according to the timestamps.

5. The method of claim 1, wherein the voice recognition results comprise a plurality of known identities, and wherein the face recognition results comprise a plurality of unknown identities.

6. The method of claim 1, wherein the sound source localization information comprises at least one of an angle and a direction of each of sound sources.

7. The method of claim 1, wherein the face recognition results comprise coordinates of a plurality of facial bounding boxes in the image frames and an identity corresponding to each of the facial bounding boxes.

8. The method of claim 1, further comprising:
obtaining a text input associated with at least one user profile;
inserting the text input into the transcript according to time series, to generate an updated transcript;
attaching the speaker's identities to the updated transcript according to the timestamps, to obtain the context; and
performing the context understanding on the context to obtain the meeting minutes report.

9. The method of claim 1, further comprising:
performing the context understanding on the context, to obtain a plurality of emotional semantics of a plurality of sentences comprised in the context;
removing a portion of the context according to the emotional semantics, to generate an updated context; and
performing summary extraction on the updated context, to obtain the meeting minutes report.

10. A system for generating meeting minutes, comprising:
a memory, configured to store a plurality of instructions and data; and
a processor, electrically connected to the memory, and wherein the processor accesses the instructions and the data stored in the memory to execute the following steps:
obtain a video signal, an audio signal and sound source localization information of a video conference;
perform face recognition on a plurality of image frames of the video signal to obtain a plurality of face recognition results;
perform voice recognition on a plurality of audio segments of the audio signal to obtain a plurality of voice recognition results at a plurality of timestamps;
match the voice recognition results with the face recognition results according to the sound source localization information, to obtain a plurality of speaker's identities;
perform speech to text transcription on the audio segments of the audio signal to obtain a transcript;
mark the speaker's identities in the transcript according to the timestamps, to obtain a context; and
perform context understanding on the context to obtain a meeting minutes report.
